(19) United States
(12) Patent Application Publication
(10) Pub. No.: US 2010/0112226 A1
(43) Pub. Date: May 6, 2010

(54) PROCESS FOR THE CURTAIN-COATING OF SUBSTRATES WITHOUT THE USE OF TENSIDES

(75) Inventors: Richard Weilbacher, Floersheim/Main (DE); Robert Fuss, Liderbach (DE)

Correspondence Address: BROOKS KUSHMAN P.C., 1000 TOWN CENTER, TWENTY-SECOND FLOOR, SOUTHFIELD, MI, 48075, US

(73) Assignee: KURARAY EUROPE GMBH, Frankfurt (DE)

(21) Appl. No.: 12/606,399

(22) Filed: Oct. 27, 2009

(30) Foreign Application Priority Data
Oct. 30, 2008 (EP) 08167930

(51) Int. Cl. B05D 3/02

(52) U.S. Cl. 427/384; 427/372.2

(57) ABSTRACT

Substrates, in particular paper, are coated by means of curtain-coating with one or more layers of hydroxyl group-containing polymers, preferably polyvinyl acetals or polyvinyl alcohols without the use of surfactants, wherein the coating composition contains at least one organic solvent. The coatings have a barrier against oil, fat and/or oxygen.

### CROSS-REFERENCE TO RELATED APPLICATIONS

This application claims priority to European Application No. 08167930 filed Oct. 30, 2008, which is herein incorporated by reference.

### BACKGROUND OF THE INVENTION

1. Field of the Invention

The invention relates to a process for coating substrates with one or more layers which contain polymers containing hydroxyl groups such as polyvinyl alcohol or polyvinyl butyrals by means of curtain-coating without the use of tensides or surfactants.

2. Background Art

The coating of substrates such as paper or cardboard packaging is carried out industrially for the production of items such as photographic papers, ink jet printing papers, graphic papers, and food packaging. Coatings for papers must be applied in the paper industry over large areas with a constant layer thickness at high paper web speeds. Non-contact methods are particularly suited for this, in which the coating application tool does not touch the substrate. Non-contact methods are, for example, the slot-die coating process, as well as spray coating and curtain-coating. The curtain-coating process is used in particular at high paper web speeds and provides uniform coating thicknesses of high quality. Curtain-coating processes are described for example in US 2003/0188839 A1, US 2006/0099410 A1 and US 2003/0194501 A1.

The quality of the curtain-coating process largely depends on the constancy of the consistency of the liquid curtain (“curtain”). Only slight fluctuations in the thickness of the curtain or in the density of the liquid are allowed to occur; otherwise, faults in the coating occur. Furthermore, the curtain must not tear off, which places high requirements on the constancy of the viscosity of the liquids which are used for coating.

In addition to a constant viscosity, the dynamic surface tension of the coating liquid which is used is important. With too high a surface tension, either no curtain forms at all, or the curtain is unstable and tears open, even up to drop formation.

To avoid these effects, the dynamic surface tension of the coating liquids which are used must be carefully adjusted. This is done by the use of surface-active substances, so-called surfactants, such as non-ionic surfactants (e.g. glycols, polyglycols or polyoxyalkylene glycols, and their derivatives) or ionic tensides. Curtain-coating processes with surfactants are disclosed for example in WO 03/0160645, US 2003/0188839, and US 2006/0009941.

In the production of coatings which are to have a barrier effect e.g. against oils or fats, the use of surfactants is a disadvantage, because these have a hydrophobic portion and thereby reduce the barrier effect against all non-polar substances.

### SUMMARY OF THE INVENTION

It was therefore an object of the present invention to provide curtain-coating processes which form stable curtains without surfactants/tensides and form coatings with a good barrier effect against gases, fats, softeners and oils. Surprisingly and unexpectedly, it was found that coatings with a good barrier effect, e.g. against fats and oils, are able to be produced by curtain-coating processes using coating liquids containing solvent, also without surfactants. In addition, the organic solvents used in the coating liquids considerably improve the drying of the coatings.

### BRIEF DESCRIPTION OF THE DRAWINGS

FIG. 1 illustrates the improvement obtained by the inventive process.

### DETAILED DESCRIPTION OF THE PREFERRED EMBODIMENT(S)

The subject of the present invention is therefore a process for coating a substrate with one or more layers by the application of coating liquids which contain one or more polymers containing hydroxyl groups as a binding agent by means of curtain-coating, wherein the coating liquids do not contain any tensides (surfactants) and contain such a high proportion of at least one organic solvent so that the coating liquids have a boiling point of less than 100° C. Through the use of an organic solvent, in addition, the subsequent drying of the coating is considerably simplified.

Preferably all organic compounds are entirely or largely miscible with water can be used as an organic solvent. By the use of the solvents, if applicable in admixture with water, the coating liquid has a boiling point which lies below 100° C., preferably below 90° C., more preferably below 80° C. and in particular below 70° C. A boiling point of the coating liquids which is below 50° C. should be avoided for reasons of safety.

Alcohols such as aliphatic alcohols with 1 to 5 carbon atoms, in particular methanol, ethanol, n-propanol, i-propanol, n-butanol, i-butanol, esters such as e.g. acetate esters, ethers such as diethyl ether, and/or ketones such as acetone, dimethyl ketone or methyl ethyl ketone are counted among the solvents which are able to be used. The use of ethanol is preferred for economic and ecological reasons.

Coating liquids used according to the invention have at least 10% by weight, preferably at least 20, 30, 40, 50, 60, 70, 80 or 90% by weight of the solvent. To establish a suitable viscosity or surface tension, it may be necessary to mix several different solvents such as different alcohols with each other, if applicable with the addition of water, for use as a solvent mixture.

Substances understood below as surfactants or tensides have a reducing effect on the dynamic surface tension of an aqueous system. In conventional curtain-coating processes, in particular ionic or non-ionic tensides are used. Non-ionic tensides are, for example, glycols, polyglycols or polyoxyalkylene glycols, such as for example the Surfynol or EnviroGem® series, ethoxylated and non-ethoxylated 2,4,7,9-tetramethyl-5-decyl-4,7-diols, oxiranes, 1,4-dimethyl-1,4-bis(2-methyl-propyl)-2-butyl-1,4-diethylether, 1,3-pentanediol, trimethylpentanediol, glycerine, Triton X100, and terstol. Ionic tensides are, for example, sodium salts of polyacrylic acids, quaternary alkyl ammonium salts (e.g. hexadecyltrimethylammonium chloride), betaines, or metal salts of fatty acids, aliphatic esters of dicarboxylic acids, and lauryl sulphates.

To form a stable curtain, it is expedient in the inventive process that the coating liquids which are used have a dynamic surface tension (Mach angle) of maximally 50 mN/m, in particular less than 40 mN/m. The Mach angle is measured as described in P. M. Schweizer, “Measurement of the Dynamic Surface Tension with the Mach Angle Method”, POLYTYPE TECHNICAL REPORT 2006, or in in “Waves in a liquid curtain”, Lin, S. P. and Roberts, G; JOURNAL OF FLUID MECHANICS, vol. 112, p. 443-458.

The theoretical bases of this method are described by Antoniades, M. G, Godwin, R., and Lin, S. P., 1980, “A new method of measuring dynamic surface tension,” JOURNAL OF COLLOID AND INTERFACE SCIENCE, 77(2), p. 583 and Brown, D. R., 1961, “A study of the behaviour of a thin sheet of moving liquid” in JOURNAL OF FLUID MECHANICS, 10, p. 297. A compilation of suitable measurement methods regarding the Mach angle is to be found in Y. M. Tricot, 1997, “Surfactants: static and dynamic surface tension”, Chapter 4 in “LIQUID FILM COATING”, edited by S. F. Kistler and P. M. Schweizer, Chapman & Hall, New York.

The process according to the invention is used in particular for the production of coatings with at least one (partial) layer with a barrier effect against gases such as nitrogen, CO₂, inert gases or oxygen; oil, fat, or softeners (plasticizers) such as, e.g. glycerine, dioctyl phthalate or diisononyl phthalate.

With the process of the invention, coatings can be produced with an excellent barrier effect against gases, oils or fats, so that the coated substrates can be used as packaging materials for foodstuffs such as pizza cartons and drinks; animal food; cosmetic articles; cleaning agents; chemicals; lubricants; or for oiled objects such as machine parts.

The barrier effect can be determined by a TAPPI T 559 kit test and/or TAPPI T 454. Preferably at least one layer produced according to the invention has a barrier greater than 5 according to a TAPPI T 559 kit test, more preferably from 6 to 12, and in particular from 7 to 12.

Alternatively or in addition, at least one layer produced according to the invention has a barrier according to TAPPI T 454 greater than 950, more preferably greater than 1050, and most preferably greater than 1100. In the TAPPI T 454 test, usually values greater than 1800 are usually not determined. However, barrier effects of 3000 are able to be achieved in the process according to the invention.

By the process according to the invention, layers with a barrier according to Cobb-Unger of less than 0.40 g/m², preferably less than 0.30 g/m² or less than 0.20 g/m² can be applied onto a substrate. Independently of this, in addition, at least one layer can have a barrier effect against oil or fat according to Cobb-Water of less than 14.0 g/m², preferably of less than 12.0 g/m². Barriers according to Cobb-Unger or Cobb-Water are determined according to DIN EM 20535 after conditioning of the material at 23° C. and 50% RH.

The barrier effect according to TAPPI T 454 and/or TAPPI T 559 kit test, or respectively Cobb-Unger or Cobb-Water refers to a single layer (i.e. a single application) and can be distinctly increased by a multiple application e.g. of two or three layers.

The applied layers or respectively the coating liquids used for this can contain, in addition to the polymers containing hydroxyl groups, further binding agents and barrier formers and optionally pigments such as chalk, kaolin, talcum, calcium carbonate, mica, titanium dioxide, silicic acid (silica) or aluminium oxide.

It is possible to use additional binding agents, e.g. lattices on the basis of styrene-butadiene, styrene-acrylate, pure acrylate, vinyl acetate, vinyl acetate copolymers or polyurethane. Furthermore, the applied layers or respectively the coating liquids used for this can contain the additives usually used in paper manufacture, such as optical brighteners and defoamers, and if applicable also cross-linking agents, rheological additives or softeners.

The proportion of the polymers containing hydroxyl groups in the coating liquid can fluctuate within wide limits and depends on the viscosity which is aimed for, on the solvent which is used, the water content, the pigment proportion and the process parameters of the coating installation such as the web speed or the thickness of the curtain. These parameters are to be determined depending on the machine and by exploratory tests.

The coating can be applied according to the invention in one or more, in particular in 2, 3 or 4 partial layers. The layers, i.e. the coating liquids which are used for this, can have the same or a different composition, i.e. they can also contain respectively different polymers containing hydroxyl groups. If the coating is built up of several partial layers, then at least one layer of the coating must have the required barrier effect.

Within the framework of the curtain-coating process according to the invention, with a multi-layer configuration the layer with the barrier effect can be applied directly onto the substrate and provided in the same working step with a further coating which contains for example printable pigments.

A first application of a conventional surface sizing agent is also conceivable, e.g. on the basis of styrene maleic acid anhydride, modified starch, styrene acrylate, or pure acrylate latex, followed by an application of polymers containing hydroxyl groups in the manner already described.

Preferred substrates for the process according to the invention are those of or with a surface to be coated, of papers, cardboard packagings or polymer foils (films). Substrates of paper or card with a weight per unit area of 10 to 100 g/m², or cardboard, in particular with a weight per unit area of over 100 g/m² are particularly suitable.

It is also possible, with the process according to the invention to coat polymer surfaces, e.g. of polyethylene, polypropylene, PET, PVC, polycarbonate, polyamide etc. The materials which are thus produced can be used in the form of foils in the field of packaging, in particular for foodstuffs.

As polymers containing hydroxyl groups in the process of the invention, e.g. starch, modified starch, cellulose, cellulose derivatives, polyvinyl alcohols, polyvinyl alcohols modified with carboxy- or silyl groups, ethylene/vinyl alcohol/vinyl acetate copolymers, polyvinyl acetals, in particular polyvinyl butyral or partially acetalized ethylene/vinyl alcohol/vinyl acetate copolymers can be used.

The solidified products of polyvinyl alcohols or ethylene/vinyl alcohol/vinyl acetal copolymers with one or more aldehydes with 2 to 10 carbon atoms, e.g. such as valeraldehyde, acetaldehyde and/or butyraldehyde are preferred as polyvinyl acetals. The degree of acetalization, the residual acetate content and the polyvinyl alcohol component can be adjusted according to the particular application or the viscosity of the coating liquids. Most preferably, polyvinyl butyral or polyvinyl-co-(butyraldehyde/acetaldehyde)acetal is used.

The polyvinyl alcohols used in the process according to the invention are produced by complete or partial hydrolysis of polyvinyl acetate and therefore also generally have vinyl acetate units in addition to vinyl alcohol units.

If a particularly good barrier effect against hydrophobic substances such as fats or oils or gas is desired, polyvinyl alcohols with a degree of hydrolysis of 90 to 99.9 mol % are preferred. The polyvinyl alcohols used according to the invention can also be modified by carboxy-, thio- or silyl groups. Copolymers of this type are obtainable under the commercial name K-, M- and R polymer etc. from Kuraray Co. Japan.

The ethylene/vinyl alcohol copolymers are produced in an analogous manner to the polyvinyl alcohols by hydrolysis of ethylene/vinyl acetate copolymers and can likewise also have vinyl acetate units. The proportion of ethylene groups is 1 to approx. 50 mol. %, in particular 1 to 15 mol %. For the degree of hydrolysis, those which are stated above for the polyvinyl alcohols applies.

By the process of the invention, polymers containing hydroxyl groups, can be applied onto the substrate in one or more layers. The layers can differ from each other in the type of polymers containing hydroxyl groups, in their thickness, or in the added additives such as pigments and the like. The substrate can thus be coated, for example, with several application coats (layers), containing respectively different polymers containing hydroxyl groups. Different polymers containing hydroxyl groups have, for example, different degrees of hydrolysis, degrees of polymerization, or degrees of acetalization, and/or are different chemically by substitution or use of different comonomers.

The coating liquids used according to the invention preferably have a viscosity, without fillers or pigments, of 5 to 2000 mPa·s with a solids content of 5 to 30% by weight.

After the application of the coating liquids, these must additionally be dried e.g. by infrared drier, hot air drier etc. Due to the solvent component of the coating liquid, attention is to be paid to corresponding safety and suction extraction installations, if applicable with a possibility of recycling of the solvents.

Suitable process parameters and equipment for carrying out the curtain-coating process, in particular for the application of coatings with several partial layers are disclosed, for example, in US 2003/0194501. In the process according to the invention, the following process parameters have proved to be particularly successful:
Viscosity of the solution/dispersion without pigments 50-500 mPa·s
Application weight in total (single- and multi-layer additively) 1-20 g/m²
With two-layer application: application weight 1st layer 1-5 g/m², 2nd layer 1-10 g/m² 1-10 g/m²
Speed of the substrate (paper) 300-1000 m/min
Solids content of the solution/dispersion without pigments 5 to 30% by weight; with pigments, 10-65% by weight.

### EXAMPLES

Solutions of the composition were produced according to Table 1 and were examined with regard to their dynamic surface tension.

TABLE 1

| | | | | Dynamic surface |
|---|---|---|---|---|
| | | Solvent | | tension Mach angle |
| No. | Polymer | Water | Ethanol | [mN/m] |
| C1 | Mowiol 15-99¹ | 100 | | 68 |
| C2 | Mowiol 15-99¹ + 0.1 | 100 | | 38 |
| | GT EnviroGem AE 03 | | | |
| 3 | Mowiol 15-99 | 70 | 30 | 37 |
| 4 | Exceval HR-3010 | 70 | 30 | 38 |

EnviroGem Tenside of the company Air Products
Mowiol 15-99 Polyvinyl alcohol of the company Kuraray Europe GmbH
Exceval HR 3010 Ethylene/Vinyl alcohol copolymer Kuraray Co Ltd.
¹Comparative Examples

Table 2 shows the barrier characteristics of coatings on raw paper (40 g/m²) with an application of 4 g/m² (dry), which were obtained with the coating liquids according to Table 1. The Comparative Example 1 and the Examples 3 and 4 were applied by means of curtain-coater, Comparative Example 2 on the basis of the high viscosity with a doctor blade.

TABLE 2

| | | | | Cobb-Water | | |
|---|---|---|---|---|---|---|
| | | | Cobb-Unger | 10 sec. | DIN 53116* | |
| No. | Solvent | KIT value | [g/m²] | [g/m²] | Stage III | Stage II |
| C1 | Water | 10 | 0.19 | 10.9 | 0/0 | 2/0 |
| C2 | Water | 5 | 0.45 | 14.1 | 1/0 | >100/50 |
| 3 | 70:30 | 10 | 0.17 | 10.8 | 0/0 | 1/0 |
| | Water:Ethanol | | | | | |
| 4 | 70 parts water | 11 | 0.16 | 9.8 | 0/0 | 1/0 |
| | 30 parts ethanol | | | | | |

*Number of small penetrations/large penetrations

### Evaluation of the Barrier Data:

KIT Value: The higher the value, the better the barrier.
Cobb-Unger: Uptake of ricinus oil. The lower the value, the better the barrier.
Cobb Water: Uptake of water within 10 seconds. The lower the value, the better the barrier.
DIN 53116: Penetration of coloured palm kernel oil under particular conditions. Stage II is more critical than Stage III. The fewer penetrations, the better.

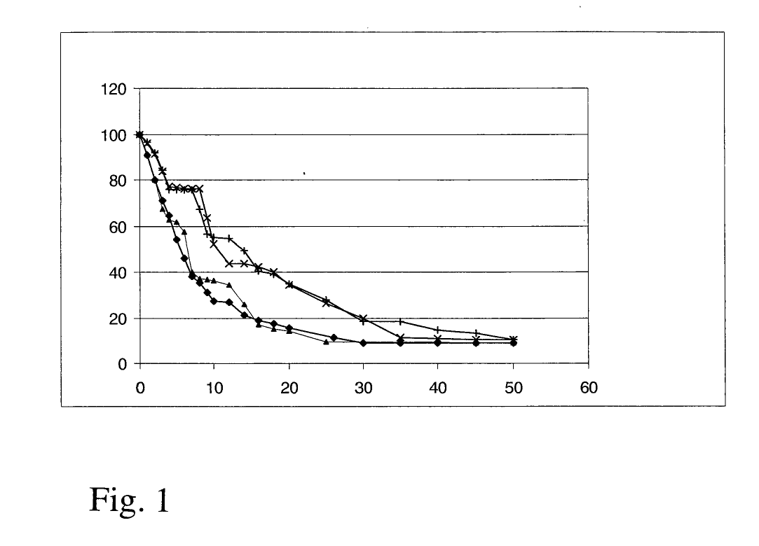

FIG. 1 shows the drying times in minutes at 90° C. of coatings of Table 2 or respectively solutions of Table 1 with a concentration of the respective polymers of 9% by weight. The drying is represented of 100% of a solution up to the dry constancy of 9% in relation to the amount of the original solution.

The curves marked by diamonds or respectively triangles correspond to the drying behaviour of solutions of Examples 3 and 4, which with curves marked “+” or respectively “x” correspond to the drying behaviour of solutions of the Comparative Example 1 and a solution of 9% by weight Exceval HR3010 in water without solvent as a comparative example to Example 4 (70:30 water:ethanol).

It is found that the use of a surfactant distinctly impairs the barrier effect. By comparison, through the process according to the invention, coatings can be obtained with a good barrier effect with, at the same time, considerably shortened drying times.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for coating a substrate with one or more layers by the application of coating liquids which contain one or more polymers containing hydroxyl groups as binding agent, comprising curtain-coating the substrate with the coating liquids followed by drying, wherein the coating liquids contain no tensides (surfactants) and contain a proportion of at least one organic solvent so that the coating liquids have a boiling point of less than 100° C.

2. The process of claim 1, wherein at least one polymer containing hydroxyl groups is selected from the group consisting of, starch, cellulose, polyvinyl alcohols, polyvinyl alcohols modified with carboxy- or silyl groups, ethylene/vinyl alcohol, vinyl acetate copolymers, polyvinyl acetals, partially acetalized ethylene/vinyl alcohol/vinyl acetate copolymers, and mixtures thereof.

3. The process of claim 1, wherein the coating liquids have a dynamic surface tension of maximally 50 mN/m.

4. The process of claim 2, wherein the coating liquids have a dynamic surface tension of maximally 50 mN/m.

5. The process of claim 1, wherein at least one layer is formed on the substrate which has a barrier effect against oil, gas, plasticizers, or fat.

6. The process of claim 4, wherein at least one layer constitutes a barrier according to the TAPPI T 559 Kit test of greater than 5.

7. The process of claim 4, wherein at least one layer constitutes a barrier according to the Cobb-Unger less of than 0.40 g/m².

8. The process of claim 6, wherein at least one layer constitutes a barrier according to the Cobb Water less of than 14.0 g/m².

9. The process of claim 1, wherein the substrate to be coated has a surface of paper, card or polymer.

10. The process of claim 1, wherein alcohols with 1 to 4 carbon atoms, esters, ethers or ketones are used as an organic solvent.

11. The process of claim 1, wherein the coating liquids contain at least 10% by weight at least of one organic solvent
